(19) United States
(12) Patent Application Publication
(10) Pub. No.: US 2022/0358380 A1
(43) Pub. Date: Nov. 10, 2022

(54) METHOD FOR FAILURE PREDICTION AND APPARATUS IMPLEMENTING THE SAME METHOD

(71) Applicant: JMSIGHT INC., Seoul (KR)

(72) Inventor: Jemin HUH, Seoul (KR)

(73) Assignee: JMSIGHT INC., Seoul (KR)

(21) Appl. No.: 17/814,646

(22) Filed: Jul. 25, 2022

Related U.S. Application Data
(63) Continuation of application No. PCT/KR2020/013329, filed on Sep. 29, 2020.

(51) Int. Cl. G06N 5/04; G06N 5/02

(52) U.S. Cl. CPC G06N 5/04; G06N 5/022

(57) ABSTRACT

A method for failure prediction and an apparatus implementing the same method are provided. According to embodiments of this disclosure, the method comprises, generating activity record data for each user using access log data, classifying each of the users into either a normal group or a failure experience group based on the activity record data and predicting an occurrence of failure using a result of a statistical test to verify a statistical significance of a difference in activity amount between the normal group and the failure experience group.

### CROSS-REFERENCE TO RELATED APPLICATION

This application is a Continuation of International Application No. PCT/KR2020/013329 filed Sep. 29, 2020, the entire content of which is incorporated herein by reference.

### TECHNICAL FIELD

The present disclosure relates to a method for failure prediction and an apparatus implementing the same method, and more particular, to a method for failure prediction that predicts service failures using an access log recorded on an Internet server, and an apparatus implementing the same.

### BACKGROUND ART

For high-capacity systems that provide users with a variety of Internet services, such as search sites and the like, the amount of the data to be processed increases exponentially, and the number of server equipment and the type of systems that are required will continue to increase.

Since the Internet services used by numerous users have the characteristic that the service needs to be delivered normally every hour of the day, it has the characteristic in a system that is sensitive to failure and is very important in reliability.

However, with the increase in the size of the system, the complexity is getting higher and higher and it is more difficult to monitor data to identify failures. In addition, since it is impossible to predict when the amount of service use increases rapidly due to disasters such as earthquakes or various social, economic, and cultural issues, from the perspective of the system, it is difficult to prepare for the occurrence of failure.

To prepare for such system failures, some Internet service companies have been detecting the occurrence of failure for themselves by quantifying the ability to recognize the state of the system based on data obtained from the system's monitoring environment.

However, this failure response is based on data obtained from the system's monitoring environment for a particular service and cannot be applied equally to other services.

In addition, for most failure predictions, data related to errors in the system are monitored, but in reality, the service experience that the user feels can be an important indicator related to service failures.

Therefore, regardless of the characteristics of the service, there is a need for a process capable of predicting and preparing in advance for the occurrence of failure by using data related to the service experience of the user.

### DISCLOSURE

### Technical Problem

Aspects of the present disclosure provide a method for failure prediction that can predict the occurrence of service failure using only an access log without a process of collecting monitoring data suitable for service characteristics, and an apparatus implementing the same.

Aspects of the present disclosure also provide a method for failure prediction that can predict an occurrence of service failures without applying different availability indicators according to service characteristics, and an apparatus implementing the same.

Aspects of the present disclosure also provide a method for failure prediction that can predict an occurrence of service failures based on a service experience of a user rather than errors in a system, and an apparatus implementing the same.

However, aspects of the present disclosure are not restricted to the one set forth herein. The above and other aspects of the present disclosure will become more apparent to one of ordinary skill in the art to which the present disclosure pertains by referencing the detailed description of the present disclosure given below.

### Solution to Problem

According to the present disclosure, a method for failure prediction performed by a computing device is provided. The method may comprise generating activity record data for each user using access log data, classifying each of the users into either a normal group or a failure experience group based on the activity record data and predicting an occurrence of failure using a result of a statistical test to verify a statistical significance of a difference in activity amount between the normal group and the failure experience group.

In some embodiments, the generating of activity record data for each user using access log data may comprise providing an application programming interface (API) for collecting the activity record data of the user to a user terminal and obtaining the activity record data generated via the API in the user terminal.

In some embodiments, the providing of an application programming interface (API) for collecting the activity record data of the user to a user terminal may comprise generating a user identifier UUID that can identify the user and transmitting the same to the user terminal.

In some embodiments, the generating of activity record data for each user using access log data may comprise generating a user identifier UUID using location information and terminal environment information of the user among the access log data.

In some embodiments, the generating of activity record data for each user using access log data may comprise identifying the user as the same user when a connection record of the user identifier UUID is maintained during a session time.

In some embodiments, the generating of activity record data for each user using access log data may comprise using characteristics of activity record data as anomaly detection data for the access log data when the characteristics of the activity record data are abnormal.

In some embodiments, the classifying of each of the users into either a normal group or a failure experience group based on the activity record data may comprise classifying the user into the failure experience group when at least one of the number of error code occurrences and the number of delays or the number of error code occurrences is greater than or equal to a preset reference value.

In some embodiments, the classifying of the user into the failure experience group when at least one of the numbers of error code occurrences and the number of delays or the number of error code occurrences is greater than or equal to a preset reference value may comprise adjusting a reference time for determining the delay.

In some embodiments, the predicting of an occurrence of failure using a result of a statistical test to verify a statistical significance of a difference in activity amount between the normal group and the failure experience group may comprise collecting data on a duration and the number of activities of users belonging to each of the normal group and the failure experience group at predetermined time intervals, performing the statistical test to verify the statistical significance of the difference between the normal group and the failure experience group using the collected data and determining whether the failure occurs based on a significance probability value (p-value) obtained as a result of performing the statistical test.

In some embodiments, a method for failure prediction performed by a computing device may further comprise detecting an error-related word (failure word) from the access log data when the service failure is determined to have occurred via the failure occurrence prediction and generating a statistical result associated with the detected error-related word for each predefined segment.

In some embodiments, the error-related word can be designated by the user.

In some embodiments, the generating of a statistical result associated with the detected error-related word for each predefined segment may comprise extracting a target segment in which the most error-related words are detected for each segment based on a variation rate calculated using a moving average value of the number of detections of the error-related words.

In some embodiments, the extracting of a target segment in which the most error-related words are detected for each segment based on a variation rate calculated using a moving average value of the number of detections of the error-related words may comprise applying different weights depending on a detection time of the error-related word when calculating the variation rate.

In some embodiments, a method for failure prediction performed by a computing device may further comprise determining a failure time and a failure cause based on the statistical results for each segment, obtaining the access log data associated with the failure cause based on the failure time and providing a detailed analysis result of the failure cause using the obtained access log data.

According to the present disclosure, a failure prediction apparatus is provided. The apparatus may comprise one or more processors, a communication interface configured to communicate with an external device a memory configured to load a computer program performed by the processor and a storage configured to store the computer programs. The computer program may comprise instructions that cause the processor to perform operations comprising: generating activity record data for each user using access log data, classifying each of the users into either a normal group or a failure experience group based on the activity record data and predicting an occurrence of failure using a result of a statistical test to verify a statistical significance of a difference in activity amount between the normal group and the failure experience group.

In some embodiments, the generating of activity record data for each user using access log data may comprise identifying the user using location information and terminal environment information among the access log data.

In some embodiments, the classifying of each of the users into either a normal group or a failure experience group based on the activity record data may comprise classifying the user into the failure experience group when at least one of the number of error code occurrences and the number of delays or the number of error code occurrences is greater than or equal to a preset reference value.

In some embodiments, the predicting of an occurrence of failure using a result of a statistical test to verify a statistical significance of a difference in activity amount between the normal group and the failure experience group may comprise collecting data on a duration and the number of activities of users belonging to each of the normal group and the failure experience group at predetermined time intervals, performing the statistical test to verify the statistical significance of the difference between the normal group and the failure experience group using the collected data and determining whether the failure occurs based on a significance probability value (p-value) obtained as a result of performing the statistical test.

In some embodiments, the computer program further comprises instructions that cause the processor to perform operations may comprise detecting an error-related word (failure word) from the access log data when the service failure is determined to have occurred via the failure occurrence prediction and generating a statistical result associated with the detected error-related word for each predefined segment.

In some embodiments, the computer program further comprises instructions that cause the processor to perform operations may comprise determining a failure time and a failure cause based on the statistical results for each segment, obtaining the access log data associated with the failure cause based on the failure time and providing a detailed analysis result of the failure cause using the obtained access log data.

### DESCRIPTION OF DRAWINGS

FIG. 1 is a schematic view of a failure prediction apparatus according to one embodiment of the present disclosure;

FIG. 2 is a diagram illustrating the configuration of a failure prediction apparatus according to one embodiment of the present disclosure;

FIGS. 3 to 6 are flowcharts of a method for failure prediction performed by a computing device according to another embodiment of the present disclosure;

FIG. 7 is a view illustrating an example of transmitting a user identifier via an exemplary API that may be provided in some embodiments of the present disclosure;

FIG. 8 is a view illustrating an example of generating a user identifier using exemplary access log data that may be provided in some embodiments of the present disclosure;

FIG. 9 is a view illustrating an example of determining whether a user is a real person based on exemplary activity record data that may be provided in some embodiments of the present disclosure;

FIG. 10 is a view illustrating an example of classifying users based on exemplary activity record data that may be provided in some embodiments of the present disclosure;

FIG. 11 is a view illustrating an example of predicting the occurrence of failures by performing an exemplary statistical test that may be provided in some embodiments of the present disclosure;

FIG. 12 is a view illustrating an example of generating a statistical result associated with the error-related word for each example predefined segment that may be provided in some embodiments of the present disclosure; and

FIG. 13 is a hardware configuration diagram of an exemplary computing device capable of implementing methods according to some embodiments of the present disclosure.

### MODE FOR DISCLOSURE

In addition, in describing the component of this disclosure, terms, such as first, second, A, B, (a), (b), can be used. These terms are only for distinguishing the components from other components, and the nature or order of the components is not limited by the terms. If a component is described as being “connected,” “coupled” or “contacted” to another component, that component may be directly connected to or contacted with that other component, but it should be understood that another component also may be “connected,” “coupled” or “contacted” between each component.

In adding reference numerals to the components of each drawing, it should be noted that the same reference numerals are assigned to the same components as much as possible even though they are shown in different drawings. In addition, in describing the present disclosure, when it is determined that the detailed description of the related well-known configuration or function may obscure the gist of the present disclosure, the detailed description thereof will be omitted.

Unless otherwise defined, all terms used in the present specification (including technical and scientific terms) may be used in a sense that can be commonly understood by those skilled in the art. In addition, the terms defined in the commonly used dictionaries are not ideally or excessively interpreted unless they are specifically defined clearly. The terminology used herein is for the purpose of describing particular embodiments only and is not intended to be limiting of the disclosure. In this specification, the singular also includes the plural unless specifically stated otherwise in the phrase.

In addition, in describing the component of this disclosure, terms, such as first, second, A, B, (a), (b), can be used. These terms are only for distinguishing the components from other components, and the nature or order of the components is not limited by the terms. If a component is described as being “connected,” “coupled” or “contacted” to another component, that component may be directly connected to or contacted with that other component, but it should be understood that another component also may be “connected,” “coupled” or “contacted” between each component.

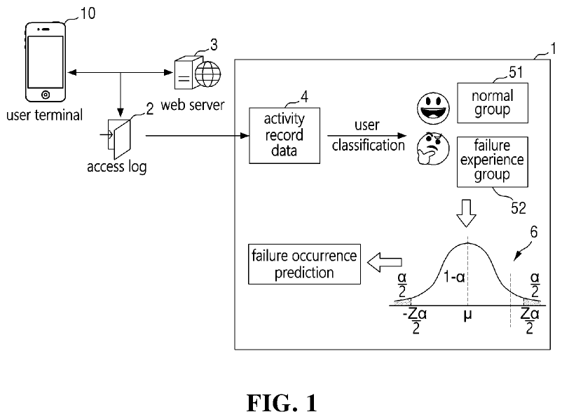

FIG. 1 is a schematic view of a failure prediction apparatus according to one embodiment of the present disclosure. Referring to FIG. 1, a failure prediction apparatus 1 according to one embodiment of the present disclosure predicts the occurrence of failures by using user activity record data extracted from access log data.

In the illustrated example, the failure prediction apparatus 1 generates activity record data 4 using access log data 2 recorded when a user terminal 10 accesses a web server 3 providing an Internet service. In this case, the activity record data 4 is generated for each user, and may include, for example, the number of error code occurrences and the number of delays corresponding to each user.

The failure prediction apparatus 1 classifies each user into a normal group 51 or a failure experience group 52 based on the activity record data 4, and predicts the occurrence of failure using a result of performing a statistical test 6 that analyzes a difference in activity amount between each of the groups.

As described above, according to the failure prediction apparatus 1 according to one embodiment of the present disclosure, the occurrence of service failures may be predicted based on a service experience of a user, not errors in a system.

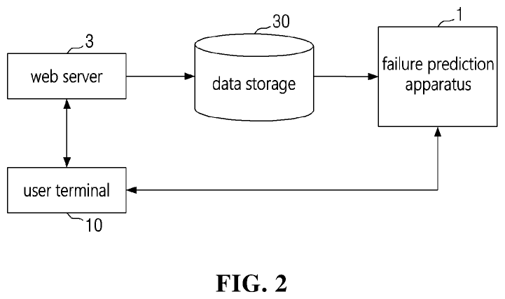

FIG. 2 is a diagram illustrating the configuration of a failure prediction apparatus according to an embodiment of the present disclosure.

Referring to FIG. 2, the failure prediction apparatus 1 according to one embodiment of the present disclosure is connected to a data storage 30 configured to store access log data generated when the user terminal 10 accesses the web server 3, via a wireless or wired communication interface.

The web server 3 is a fixed computing device and connected to the user terminal 10 via a network and processes a response to an HTTP request from a web browser of the user terminal 10. The web server 3 may be implemented as a WAS server capable of processing dynamic content or a web application service and interworking with a database 30.

The failure prediction apparatus 1 is the fixed computing device and is connected to the data storage 30 via the network, and generates the activity record data 4 for each user using access log data stored in the data storage 30.

As one embodiment, when an application programming interface (API) for collecting activity record data of the user is provided from the web server 3 to the user terminal 10, the failure prediction apparatus 1 may obtain the activity record data 4 generated via the API in the user terminal 10. The API may include, for example, a software development kit (SDK).

Herein, when the web server 3 provides the API to the user terminal 10, the API including a user identifier UUID capable of identifying the user is transmitted to the user terminal 10 to assign a unique user identifier UUID for the corresponding user terminal 10. Accordingly, when the user terminal 10 accesses the web server 3, information on the user identifier UUID assigned to the user terminal 10 as the access log data may be recorded together in the data storage 30. Accordingly, the failure prediction apparatus 1 may generate the activity record data 4 for each user from the access log data using the user identifier UUID stored in the data storage 30.

In another embodiment, the failure prediction apparatus 1 may generate the user identifier UUID by using user location information and terminal environment information among the access log data stored in the data storage 30 Accordingly, the failure prediction apparatus 1 may generate the activity record data 4 for each user from the access log data.

The failure prediction apparatus 1 classifies each user into the normal group 51 or the failure experience group 52 based on the activity record data 4 generated by the aforementioned method. The failure experience group 52 may include users who have had a bad experience while using the Internet service provided by the web server 3, and may include, for example, the number of error code occurrences and the number of delays among the activity record data 4 for each user, as an indicator of the bad experience.

The failure prediction apparatus 1 performs the statistical test that analyzes the difference in activity of users between the normal group 51 or the failure experience group 52 and predicts the occurrence of the failure from the result. Herein, as the statistical test used to analyze the difference between the two groups, for example, a two-sample T-test technique may be used.

The data storage 30 may be implemented with a separate external device or a DB server connected to the failure prediction apparatus 1 and the web server 3 via the network, and may store all information such as information on the user terminal 20 connected to the web server 3, a connected web page and the access time.

The user terminal 20 may be one of a fixed computing device such as a personal desktop PC, and a mobile computing device such as a smartphone, a tablet PC, a laptop PC or a PDA. The user terminal 20 may receive various contents provided by the web server 3 by accessing the web server 3 and selecting web pages, and may upload the contents prepared by the user terminal 20 to the web server 3.

As described above, in accordance with the failure prediction apparatus 1 according to one embodiment of the present disclosure, the service failure may be predicted by using only the access log without the separate process of collecting monitoring data suitable for service characteristics.

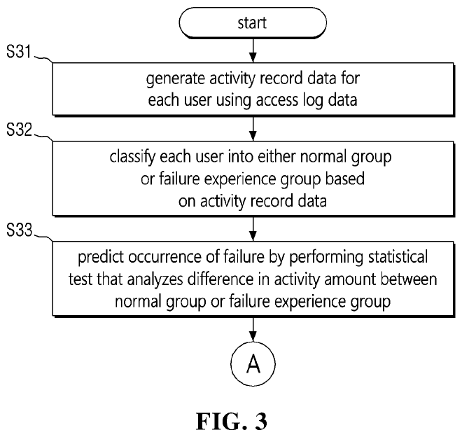

FIGS. 3 to 6 are flowcharts of a method for failure prediction performed by a computing device according to another embodiment of the present disclosure. The method according to the present embodiment may be executed by the computing device, for example, by the failure prediction apparatus 1.

The computing device that executes the method according to the present embodiment may be a computing device with an application execution environment. It is noted that a description of the subject of performing some operations included in the method according to the present embodiment may be omitted, and in such a case, the subject is the computing device.

Referring to FIG. 3, first, in an operation S31, the activity record data 4 for each user is generated using the access log data 2.

As one embodiment, the operation S31 may include an operation of providing the API for collecting the activity record data of the user to the user terminal 10 and an operation of obtaining the activity record data 4 generated via the API in the user terminal 10. In this case, when the API is provided to the user terminal 10, the user identifier UUID capable of identifying the user may be generated and transmitted to the user terminal 10. Accordingly, the activity record data 4 for each user may be generated by using the user identifier UUID included in the access log data recorded when the user terminal 10 accesses the web server 3.

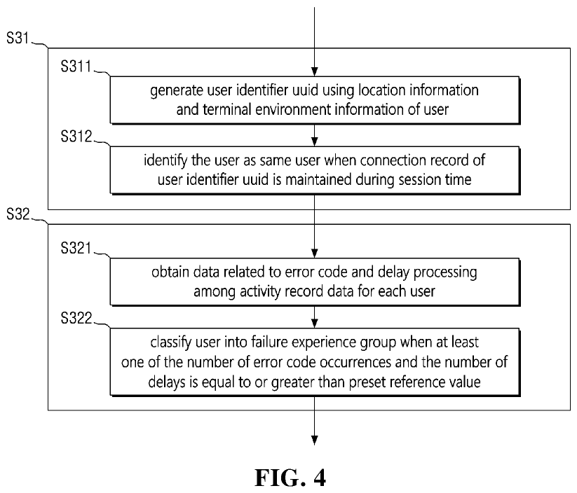

According to another embodiment, referring to FIG. 4, the operation S31 may include an operation S311 in which the user identifier UUID is generated using the location information and the terminal environment information of the access log data 2, and an operation S312 in which, when a connection record of the user identifier UUID is maintained during a session time, the user is identified as the same user. Herein, in the operation S311, for example, an IP address may be used as location information of the user, and for example, agent software/w-related information used when the user terminal 10 accesses the web server 3 may be used as the terminal environment information.

In operation S312, when the connection is maintained for a session time of for example, 30 minutes in the connection record of the user identifier UUID included in the access log data 2, it may be determined as the same user's access. In this case, the session time may be set to a maximum of 3 hours, and the connection after the session time may be determined as another user's access.

Next, in an operation S32, each user is classified into the normal group 51 or the failure experience group 52 based on the activity record data 4.

As one embodiment, referring to FIG. 4, the operation S31 includes an operation S321 in which data related to an error code and delay processing is obtained among the activity record data 4 for each user, and an operation S322 in which the user is classified into the failure experience group when at least one of the number of error code occurrences and the number of delays is equal to or greater than a preset reference value.

In this case, the operation S322 may include an operation of determining whether the number of error code occurrences or the number of delays is equal to or greater than the preset reference value by applying different weights to the number of error code occurrences and the number of delays corresponding to the user. In addition, the operation S322 may include an operation in which a reference time for determining delay processing is adjusted.

Finally, in the operation S33, failure occurrence is predicted using the results of performing the statistical test that analyzes the difference in activity amount between the normal group 51 or the failure experience group 52.

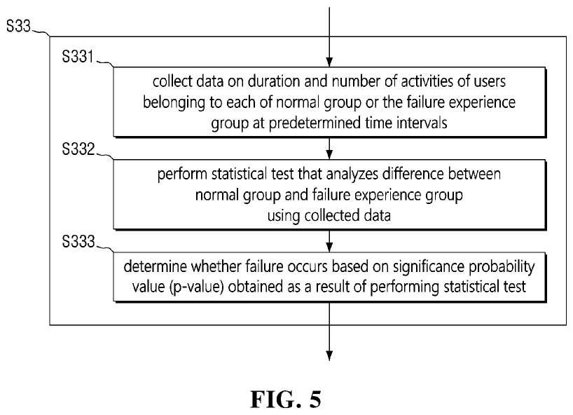

As one embodiment, referring to FIG. 5, the operation S33 may include an operation S331 in which data on the duration and number of activities of users belonging to each of the normal group or the failure experience group are collected at predetermined time intervals, an operation S332 of performing the statistical test that analyzes the difference between the normal group and the failure experience group using the collected data, and an operating S333 of determining whether the failure occurs based on a significance probability value (p-value) obtained as a result of performing the statistical test.

For example, in the operation S332, as a statistical test method for analyzing the difference between the normal group and the experience group, for example, a two-sample T-test technique may be used. Herein, the two-sample T-test technique is a way to verify the statistical significance of a mean difference between two groups, and is used when a variance or standard deviation of a population is not known and is tested using the variance or standard deviation estimated from a sample.

In the operation S333, the significance probability value (p-value) represents a probability that a test statistic value of observed data supports a null hypothesis, and the smaller the value is, the weaker the degree of supporting the null hypothesis is, thus rejecting the null hypothesis, and the larger the value is, the greater the degree of supporting the null hypothesis is, thus adopting the null hypothesis. In general, when the significance probability value (p-value) is less than 5%, the null hypothesis may be rejected to determine the same value to be statistically meaningful.

For example, assuming that there is no difference between the normal group 51 and the failure experience group 52 when performing the operations S332 and S333, when the significance probability value (p-value) calculated using the T-test technique is 5% or less, the null hypothesis may be rejected to determine that failure has taken place, and when the significance probability value (p-value) is more than 5% and less than 50%, the probability of failure may be determined to have increased. In addition, when the significance probability value (p-value) is 50% or more, an accidental or minor failure may be determined to have occurred.

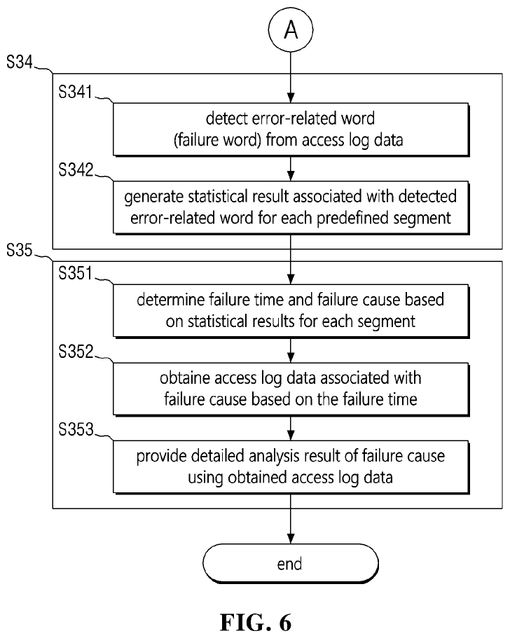

As one embodiment, referring to FIG. 6, an operation S34 and an operation S35 may be further performed after the occurrence of the failure is predicted by the execution of the operation S33.

In the operation S34, when the service failure is determined to have occurred by a failure occurrence prediction, an operation S341 in which an error-related word (failure word) is detected from the access log data 2 and an operation S342 in which a statistical result associated with the detected error-related word for each predefined segment is generated may be performed.

Herein, the error-related word (failure word) is a word well known for error occurrence in the access log data, and may include, for example, error, Error, FATAL, EXCEPTION, Fail, Failure, critical, and the like.

In one embodiment, the error-related word (failure word) may be directly designated by the user, and a level of failure may be set for each word.

A segment may be designated as, for example, a service, a hostname, an application, and a log path. The segment may be further designated by the user in addition to the predetermined one.

In the operation S342, when generating the statistical result associated with the error-related word, statistics regarding a detection order of the error-related word may be calculated for each segment. For example, targets may be extracted in the order in which the number of detections of the error-related words is high for each service, each hostname and each application.

As one embodiment, the operation S342 may include an operation of extracting a target in which the most error-related words are detected for each segment based on a variation rate calculated using a moving average value of the number of detections of the error-related words. In this case, a larger weight may be applied to a past time when calculating the variation rate.

In the operation S35, an operation S351 of determining a failure time and a failure cause based on the statistical results for each segment, an operation S352 of obtaining the access log data associated with the failure cause based on the failure time, and an operation S353 of providing a detailed analysis result of the failure cause using the obtained access log data may be performed.

For example, from the statistical results for each segment generated by performing the operation 342, the target with a high number of detections of the error-related words may be determined to be associated with the failure cause, and a detailed analysis result of the failure cause may be provided by searching for all peripheral access log data based on the time when the error-related word is detected.

According to the method according to one embodiment of the present disclosure, the service failures may be predicted by using only the access log data without the separate process of collecting monitored data suitable for the service characteristics. In addition, it is possible to predict the occurrence of service failure without applying different availability indicators according to the characteristics of the service.

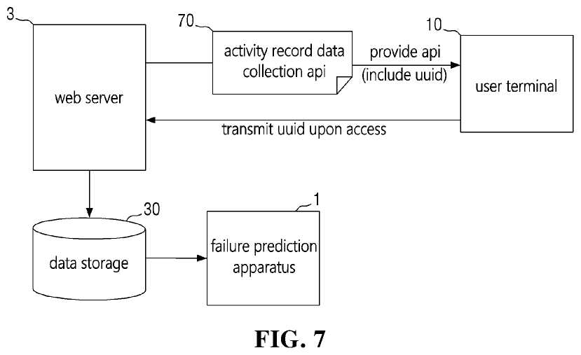

FIG. 7 is a view illustrating an example of transmitting a user identifier via an exemplary API that may be provided in some embodiments of the present disclosure. In the illustrated example, when the application programming interface (API) for collecting the activity record data of the user is provided from the web server 3 to the user terminal 10, the failure prediction apparatus 1 may obtain the activity record data 4 generated via the API from the user terminal 10.

For example, when the web server 3 provides the API to the user terminal 10, the API including the user identifier UUID capable of identifying the user may be transmitted to the user terminal 10 to assign the unique user identifier UUID for the user terminal 10.

Accordingly, when the user terminal 10 accesses the web server 3, the information on the user identifier UUID assigned to the user terminal 10 as the access log data may be transmitted and recorded in the data storage 30.

Accordingly, the failure prediction apparatus 1 may generate the activity record data 4 for each user from the access log data using the user identifier UUID stored in the data storage 30.

According to one embodiment of the present disclosure as described above, information capable of identifying the user may be added to the access log data recorded when the user terminal 10 accesses the web server 3.

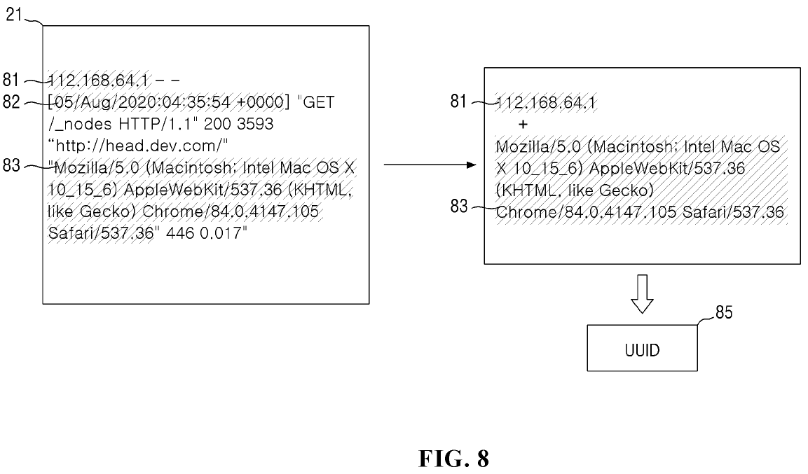

FIG. 8 is a view illustrating an example of generating a user identifier using exemplary access log data that may be provided in some embodiments of the present disclosure. In the illustrated example, the failure prediction apparatus 1 may generate the user identifier UUID using location information and terminal environment information of the user of the access log data recorded when the user terminal 10 accesses the web server 3.

For example, the failure prediction apparatus 1 may generate an IP address 81 via which a location of the user terminal 10 can be known from the access log data 21 and a user identifier UUID 85 using a combination of terminal environment information 83 that can know the type and version of agent software (agent s/w) that is being used by the user terminal 10 to access the web server 3.

In this case, when the access record of the user identifier UUID is maintained within, for example, a session time of about 30 minutes, based on an access record time 82 included in the access log data 21, the same user may be determined to have accessed the server. In this case, the session time may be set to a maximum of 3 hours, and access after the session time may be determined as another user's access.

According to an embodiment of the present disclosure as described above, the user may be identified by using some information of the access log data recorded when the user terminal 10 accesses the web server 3.

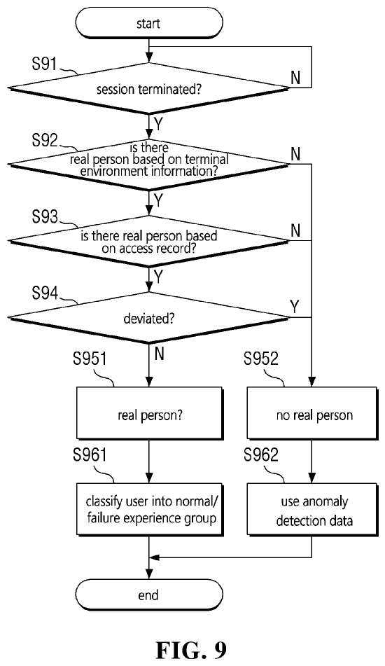

FIG. 9 is a view illustrating an example of determining whether the user is a real person based on exemplary activity record data that may be provided in some embodiments of the present disclosure. In the illustrated example, when characteristics of the activity record data 4 generated from the access log data 2 are determined not to be a person, the failure prediction apparatus 1 may not use the characteristics as data for user classification, but may use the characteristics as abnormal detection data.

As illustrated, in an operation S91, when the session corresponding to the user identifier UUID 85 is determined to be terminated, in an operation S92, it is determined whether the user is a real person based on the terminal environment information 83 included in the activity record data 4. In this case, when the terminal environment information 83 corresponds to previously known information that the user is not the real person, corresponding data may be removed from the activity record data 4.

As a result of performing the operation S92, when the user is determined as the real person based on the terminal environment information 83, in an operation S93, it is determined whether the user is the real person based on the access record of the user identifier UUID 85. For example, when the IP address is not a real person's, the corresponding data may be removed from the activity record data 4. Furthermore, even if the IP address keeps accessing repeatedly, it is determined not to be the real person's, and the corresponding data may be removed from activity record data 4.

Next, as a result of performing the operation S93, when the user is determined as the real person based on the access record, in the operation S94, it is additionally determined whether the user deviates from the access. For example, when there is only one access record of the user identifier UUID 85, the user may be determined to be a deviated user, and the corresponding data may be removed from the activity record data 4.

As a result of performing the operation S94, when it is determined that the user fails to deviate from access, in an operation 951, the characteristic of the corresponding data is determined as the activity record data 4 corresponding to the real person, and accordingly, in an operation S961, the user may be classified into either the normal group or the failure experience group based on the activity record data 4.

As a result of performing the operation S94, when the user is determined to have deviated from access, in an operation 952, the characteristic of the corresponding data is determined not to correspond to the real person, and then the corresponding data may be removed from the activity record data 4. In an operation 962, the removed data may be used as separate anomaly detection data.

According to one embodiment of the present disclosure as described above, when the characteristics of the activity record data generated from the access log are not a person, they may be used as data for anomaly detection.

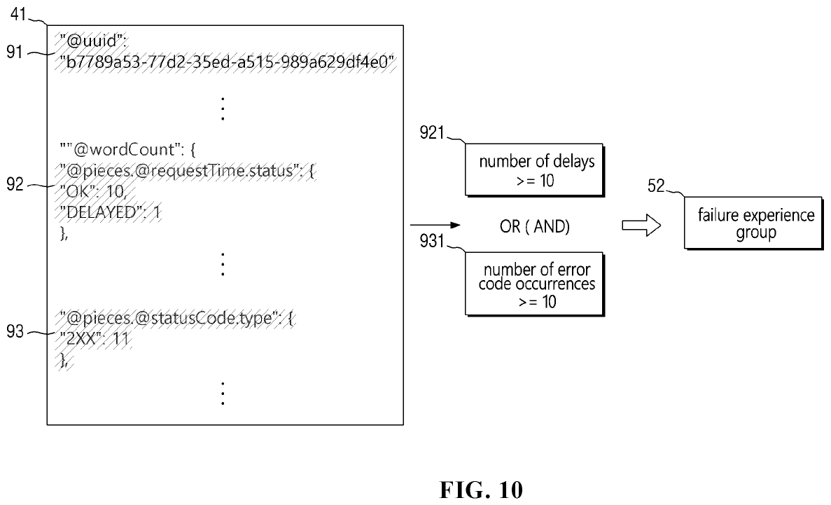

FIG. 10 is a view illustrating an example of classifying users based on exemplary activity record data that may be provided in some embodiments of the present disclosure. In the illustrated example, the failure prediction apparatus 1 may classify the user into either the normal group 51 or the failure experience group 52 based on activity record data 41 generated from the access log data 21.

As one embodiment, the failure prediction apparatus 1 may classify the user into either the normal group 51 or the failure experience group 52 using delay processing information 92 and error occurrence information 93 corresponding to a user identifier UUID 91 in the activity record data 41 for each other. Herein, the delay processing information 92 may include, for example, the number of delays such as “DELAYED,” and error generation information 93 may include, for example, the number of error code occurrences such as “2XX.” For example, when the number of delays or the number of error code occurrences is greater than or equal to a preset reference value (e.g., 10 cases), the failure prediction apparatus 1 may classify the user into the failure experience group 52.

That is, the failure experience group 52 may include users who have had a bad experience while using the Internet service provided by the web server 3, and may include, for example, the number of error code occurrences and the number of delays among the activity record data 4 for each user as an indicator of the bad experience.

According to one embodiment of the present disclosure as described above, it is possible to distinguish the users who have had the bad experience while using the service by using the activity record data for each user generated from the access log data.

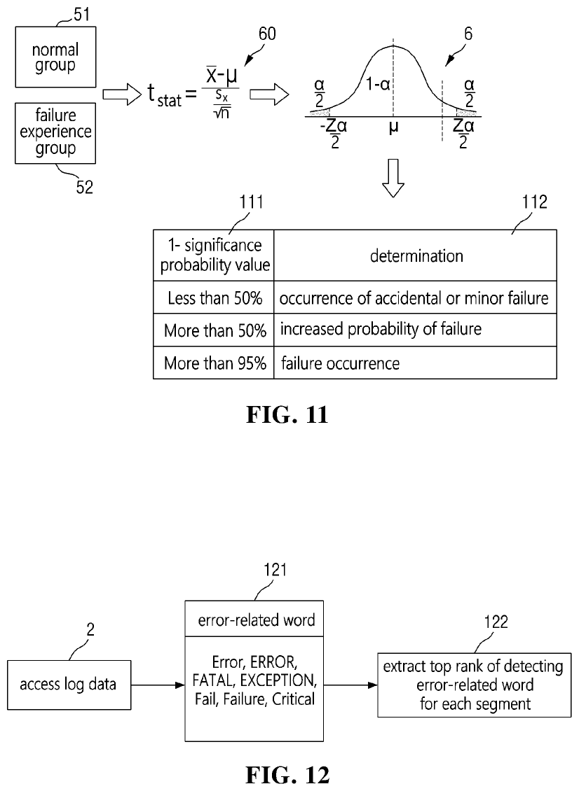

FIG. 11 is a view illustrating an example of predicting the occurrence of failure by performing an exemplary statistical test that may be provided in some embodiments of the present disclosure. In the illustrated example, to analyze a difference in activity amount between the normal group 51 and the failure experience group 52, the failure prediction apparatus 1 may collect data on activity duration and the number of activities from the activity record data 4 of the users belonging to each group at predetermined time intervals. For example, the activity duration and the number of activities may be collected using values of “activityDuration” and “activityCount” among the activity record data 4.

The failure prediction apparatus 1 may perform the statistical test that analyzes the difference in activity amount between the normal group 51 and the disability experience group 52 using the data on the activity duration and the number of activities collected as described above. In this case, as the statistical test method, for example, the two-sample T-test technique may be used. The two-sample T-test technique is a way to verify the statistical significance of the mean difference between the two groups, and is tested using a T-test statistic 60 calculated using an estimated variance or standard deviation from the sample.

The failure prediction apparatus 1 may obtain the significance probability value (p-value) via a test result 6 associated with the distribution of the calculated T-test statistic 60, and may measure the occurrence of the failure using the same value.

For example, assuming that there is no difference between the normal group 51 and the failure experience group 52, the failure prediction apparatus 1 may determine the possibility of the failure occurrence using a “1-significant probability value” 111 calculated using the T-test technique. For example, when the “1-significant probability value” 111 is 95% or more, the failure is determined to have occurred by rejecting the null hypothesis, and the possibility of failures of 50% or more and less than 95% is determined to increase. In addition, when the “1-significant probability value” 111 is less than 50%, an accidental or minor failure is determined to have occurred.

According to an embodiment of the present disclosure described above, the user may be classified using only the access log data without the separate process of collecting the monitored the data suitable for the service characteristics, and the occurrence of the service failure may be predicted by the statistical test for the difference between the classified user groups.

FIG. 12 is a view illustrating an example of generating a statistical result associated with the error-related word for each example predefined segment that may be provided in some embodiments of the present disclosure. In the illustrated example, when the service failure is determined to have occurred via the failure occurrence prediction, the failure prediction apparatus 1 may detect an error-related word 121 from the access log data 2. Herein, the error-related word (failure word) is a word well known for error occurrence in the access log data, and may include, for example, error, Error, FATAL, EXCEPTION, Fail, Failure, critical, and the like.

The failure prediction apparatus 1 may generate the statistical result associated with the detected error-related word 121 for each predefined segment. Herein, the segment may be designated as, for example, a service, a hostname, an application, and a log path. The segment may be further designated by the user in addition to the predetermined one.

When generating the statistical result associated with the error-related word, the failure prediction apparatus 1 may calculate statistics 122 for the detection order of the error-related word for each segment. For example, the targets may be extracted in the order in which the number of detections of the error-related words is high for each service, each hostname and each application.

The failure prediction apparatus 1 may identify the failure time and the failure cause based on the statistical results for each segment based on the statistical result for each segment as described above, and may provide a detailed analysis result of the failure cause using the access log data based on the failure time.

According to one embodiment of the present disclosure as described above, the failure may be predicted based on the service experience of the user from the access log data, and the statistical results associated with the failure cause may be provided.

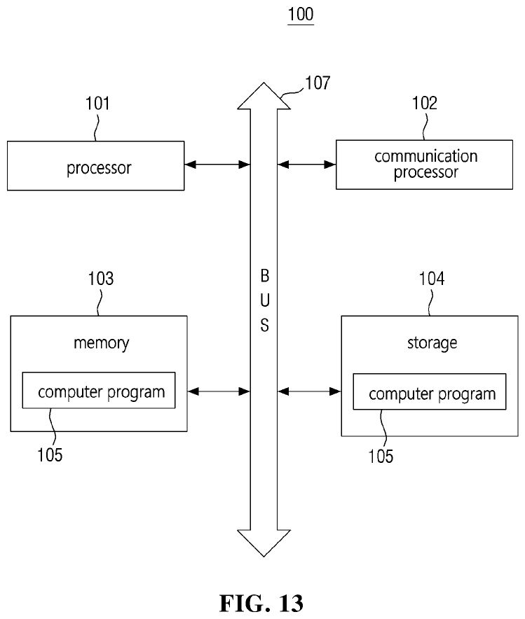

FIG. 13 is a hardware configuration diagram of an exemplary computing device capable of implementing methods according to some embodiments of the present disclosure. As illustrated, a computing device 100 may include one or more processors 101, a bus 107, a network interface 102, a memory 103 configured to load a computer program 105 performed by the processor 101, and a storage 104 configured to store the computer program 105. However, in FIG. 13, only components related to the embodiment of the present disclosure are illustrated. Therefore, it may be seen by those skilled in the art to which the present disclosure belongs that other universal components may be further included in addition to the components illustrated in FIG. 13.

The processor 101 controls overall operations of each component of the computing device 100. The processor 101 may include at least one of a central processing unit (CPU), a micro-processor unit (MPU), a micro-controller unit (MCU), a graphical processing unit (GPU), or any type of processor known in the technical field of the present disclosure. In addition, the processor 101 may perform arithmetic operations for at least one application or program for the purpose of executing the method/operation according to various embodiments of the present disclosure. The computing device 100 may include one or more processors.

The memory 103 stores different kinds of data, instructions, and/or information. The memory 103 may load one or more programs 105 from the storage 104 to execute the methods/operations according to various embodiments of the present disclosure. For example, when the computer program 105 is loaded into the memory 103, logic (or module) may be implemented on the memory 103. An example of the memory 103 may be RAM, but the present disclosure is not limited thereto.

The bus 107 provides a communication function between the components of the computing device 100. The bus 107 may be implemented as various types of buses such as an address bus, a data bus, and a control bus.

The network interface 102 supports wired and wireless Internet communication of the computing device 100. The network interface 102 may support a variety of communication methods other than Internet communication. To this end, the network interface 102 may include a communication module known in the art of the present disclosure.

The storage 104 may non-temporarily store the one or more computer programs 105. The storage 104 may include non-volatile memory, such as a flash memory, a hard disk, a removable disk, or any type of computer-readable recording medium known in the technical field to which the present disclosure belongs.

The computer program 105 may include one or more instructions in which methods/operations according to various embodiments of the present disclosure are implemented. When the computer program 105 is loaded into the memory 103, the processor 101 may perform the methods/operations according to various embodiments of the present disclosure by executing the one or more instructions.

The technical features of the present disclosure described so far may be embodied as computer readable codes on a computer readable medium. The computer readable medium may be, for example, a removable recording medium (CD, DVD, Blu-ray disc, USB storage device, removable hard disk) or a fixed recording medium (ROM, RAM, computer equipped hard disk). The computer program recorded on the computer readable medium may be transmitted to other computing device via a network such as internet and installed in the other computing device, thereby being used in the other computing device.

Although operations are shown in a specific order in the drawings, it should not be understood that desired results can be obtained when the operations must be performed in the specific order or sequential order or when all of the operations must be performed. In certain situations, multitasking and parallel processing may be advantageous. According to the above-described embodiments, it should not be understood that the separation of various configurations is necessarily required, and it should be understood that the described program components and systems may generally be integrated together into a single software product or be packaged into multiple software products.

In concluding the detailed description, those skilled in the art will appreciate that many variations and modifications can be made to the preferred embodiments without substantially departing from the principles of the present disclosure. Therefore, the disclosed preferred embodiments of the disclosure are used in a generic and descriptive sense only and not for purposes of limitation.

1. A method for failure prediction performed by a computing device, the method comprising:
generating activity record data for each user using access log data;
classifying each of the users into either a normal group or a failure experience group based on the activity record data; and
predicting an occurrence of failure using a result of a statistical test to verify a statistical significance of a difference in activity amount between the normal group and the failure experience group.

2. The method for failure prediction of claim 1, wherein the generating of activity record data for each user using access log data comprises:
generating a user identifier (UUID) that can identify the user and transmitting the user identifier to the user terminal; and obtaining the activity record data generated via the user identifier UUID.

3. The method for failure prediction of claim 1, wherein the generating of activity record data for each user using access log data comprises:
generating the user identifier using location information and terminal environment information of the user among the access log data.

4. The method for failure prediction of claim 3, wherein the generating of activity record data for each user using access log data comprises:
identifying the user as the same user when a connection record of the user identifier is maintained during a session time.

5. The method for failure prediction of claim 1, wherein the generating of activity record data for each user using access log data comprises:
using characteristics of activity record data as anomaly detection data for the access log data when the characteristics of the activity record data are abnormal.

6. The method for failure prediction of claim 1, wherein the classifying of each of the users into either a normal group or a failure experience group based on the activity record data comprises:
classifying the user into the failure experience group when at least one of the number of error code occurrences and the number of delays or the number of error code occurrences is greater than or equal to a preset reference value.

7. The method for failure prediction of claim 6, wherein the classifying of the user into the failure experience group when at least one of the number of error code occurrences and the number of delays or the number of error code occurrences is greater than or equal to a preset reference value comprises:
adjusting a reference time for determining the delay.

8. The method for failure prediction of claim 1, wherein the predicting of an occurrence of failure using a result of a statistical test to verify a statistical significance of a difference in activity amount between the normal group and the failure experience group comprises:
collecting data on a duration and the number of activities of users belonging to each of the normal group and the failure experience group at predetermined time intervals;
performing the statistical test to verify the statistical significance of the difference between the normal group and the failure experience group using the collected data; and
determining whether the failure occurs based on a significance probability value (p-value) obtained as a result of performing the statistical test.

9. The method for failure prediction of claim 1, further comprising: when the service failure is determined to have occurred via the failure occurrence prediction,
detecting an error-related word (failure word) from the access log data; and
generating a statistical result associated with the detected error-related word for each predefined segment.

10. The method for failure prediction of claim 9, wherein the error-related word can be designated by the user.

11. The method for failure prediction of claim 9, wherein the generating of a statistical result associated with the detected error-related word for each predefined segment comprises:
extracting a target segment in which the most error-related words are detected for each segment based on a variation rate calculated using a moving average value of the number of detections of the error-related words.

12. The method for failure prediction of claim 11, wherein the extracting of a target segment in which the most error-related words are detected for each segment based on a variation rate calculated using a moving average value of the number of detections of the error-related words comprises:
applying different weights depending on a detection time of the error-related word when calculating the variation rate.

13. The method for failure prediction of claim 9, further comprising:
determining a failure time and a failure cause based on the statistical results for each segment;
obtaining the access log data associated with the failure cause based on the failure time; and
providing a detailed analysis result of the failure cause using the obtained access log data.

14. A failure prediction apparatus comprising:
one or more processors;
a communication interface configured to communicate with an external device;
a memory configured to load a computer program performed by the processor; and
a storage configured to store the computer programs,
wherein the computer program comprises instructions that cause the processor to perform operations comprising:
generating activity record data for each user using access log data;
classifying each of the users into either a normal group or a failure experience group based on the activity record data; and
predicting an occurrence of failure using a result of a statistical test to verify a statistical significance of a difference in activity amount between the normal group and the failure experience group.

15. The failure prediction apparatus of claim 14, wherein the generating of activity record data for each user using access log data comprises:
Identifying the user using location information and terminal environment information among the access log data.

16. The failure prediction apparatus of claim 14, wherein the classifying of each of the users into either a normal group or a failure experience group based on the activity record data comprises:
classifying the user into the failure experience group when at least one of the number of error code occurrences and the number of delays or the number of error code occurrences is greater than or equal to a preset reference value.

17. The failure prediction apparatus of claim 14, wherein the predicting of an occurrence of failure using a result of a statistical test to verify a statistical significance of a difference in activity amount between the normal group and the failure experience group comprises:
collecting data on a duration and the number of activities of users belonging to each of the normal group and the failure experience group at predetermined time intervals;
performing the statistical test to verify the statistical significance of the difference between the normal group and the failure experience group using the collected data; and
determining whether the failure occurs based on a significance probability value (p-value) obtained as a result of performing the statistical test.

18. The failure prediction apparatus of claim 14, wherein the computer program further comprises instructions that cause the processor to perform operations comprising: when the service failure is determined to have occurred via the failure occurrence prediction,
detecting an error-related word (failure word) from the access log data; and
generating a statistical result associated with the detected error-related word for each predefined segment.

19. The failure prediction apparatus of claim 18, wherein the computer program further comprises instructions that cause the processor to perform operations comprising:
determining a failure time and a failure cause based on the statistical results for each segment;
obtaining the access log data associated with the failure cause based on the failure time; and
providing a detailed analysis result of the failure cause using the obtained access log data.
